(19) United States
(12) Patent Application Publication
(10) Pub. No.: US 2003/0174453 A1
(43) Pub. Date: Sep. 18, 2003

(54) Power protection

(76) Inventors: Chia-Chang Hsu, Hsin Chu (TW); Chung-Hsien Lin, Pan Chaio City (TW); Yen-Chung Chen, Ho Mei Chen (TW)

Correspondence Address: MARTINE & PENILLA, LLP, 710 LAKEWAY DRIVE, SUITE 170, SUNNYVALE, CA, 94085, US

(21) Appl. No.: 10/159,328

(22) Filed: May 31, 2002

(30) Foreign Application Priority Data
Mar. 15, 2002 (TW) 91105022

(51) Int. Cl. H02H 3/18

(52) U.S. Cl. 361/78

(57) ABSTRACT

A circuit for power protection comprising a power supply switching unit for switching a power supply off according to a switching-off signal, a surge voltage protective unit for outputting the switching-off signal while a surge voltage is occurred, a leakage current protective unit for outputting the switching-off signal while a leakage current is occurred, an overload current protective unit for outputting the switching-off signal while an overload current is occurred, an over/under voltage protective unit for outputting the switching-off signal while an over/under voltage is occurred, and a temperature protective unit for outputting the switching-off signal while an over-temperature is occurred. The present invention has the effects of the surge voltage protection, the leakage current protection, the overload current protection, the over/under voltage protection, and the over-temperature protection at the same time, and, in comparison with a conventional circuit for power protection, the volume of the circuit is more reduced and the cost thereof is also reduced. Further, it may determine the overload current according to the accumulated energy so as to have the more precise and safer protection.

### BACKGROUND OF THE INVENTION

1. Field of the Invention

The present invention relates to a circuit for power protection, particularly to a circuit capable of protecting the damages caused by a surge voltage, a leakage current, an overload current, an over/under voltage, or an over-temperature simultaneously.

2. Description of the Related Art

Computers, washing machines, microwave ovens, air conditioners, and refrigerators have become daily appliances with the advancement in technology, and followed by the improvement in the quality of life. Nevertheless, the more the power consumption of the electrical appliances is increased, the more potential damages are increased. In specific, unusual phenomenon regarding the power consumption of the electrical appliances are generally an overload current, a leakage current, a surge voltage, an over/under voltage, and an over-temperature.

The overload current denotes the current through the electrical appliances is unusually increased and it even causes the fire. The leakage current often occurs in the humid environment, such as a bathroom, so that the current, for example, the current of 8 mA or the above will cause an electric shock. The surge voltage denotes the occurrence of a short and sudden high voltage such that the electrical appliances are damaged. The over/under voltage is caused by the instability in voltage of the power supply. The over-temperature is caused by the unusual load on the electrical appliances.

A conventional circuit for power protection is aimed at above-mentioned power supply unusual phenomenon so as to adopt corresponding circuits for power protection. For example, fuses are provided in the extended electric wire so as to have the surge voltage protective device and further prevent the damage of the surge voltage. Still, it may prevent the electrical appliances from damages caused by the overload current by means of the fuses, mechanical overload current switches, or devices composed of current-detecting circuits.

However, the conventional circuit for power protection is merely aimed at one of the above-mentioned unusual phenomenon, and it required a combination of the circuits for power protection to solve those power supply unusual phenomenon at the same time. It must purchase many circuits for each function, such that the cost is increased and it is difficult to construct a power supply protective system.

### SUMMARY OF THE INVENTION

Therefore, it is an object of the present invention to provide a circuit for power protection capable of protecting the damages caused by at least one of the surge voltage, the leakage current, the overload current, the over/under voltage, and the over-temperature simultaneously.

It is another object of the present invention to provide a circuit for power protection, which has a more reduced volume than that of a conventional circuit and thereby a reduced cost, a more precise and safer protection is obtained.

Other advantages of the invention will become apparent from the following detailed description, taken in conjunction with the accompanying drawings, illustrating by way of example the principles of the invention.

### BRIEF DESCRIPTION OF THE DRAWINGS

FIG. 1 is a schematic block diagram showing the circuit for power protection according to an embodiment of the present invention.

FIG. 2 is a detailed block diagram showing the circuit for power protection according to the embodiment of the present invention, wherein one example of the overload current protective unit is shown.

FIG. 3 is a detailed block diagram showing the circuit for power protection according to the embodiment of the present invention, wherein another example of the overload current protective unit is shown.

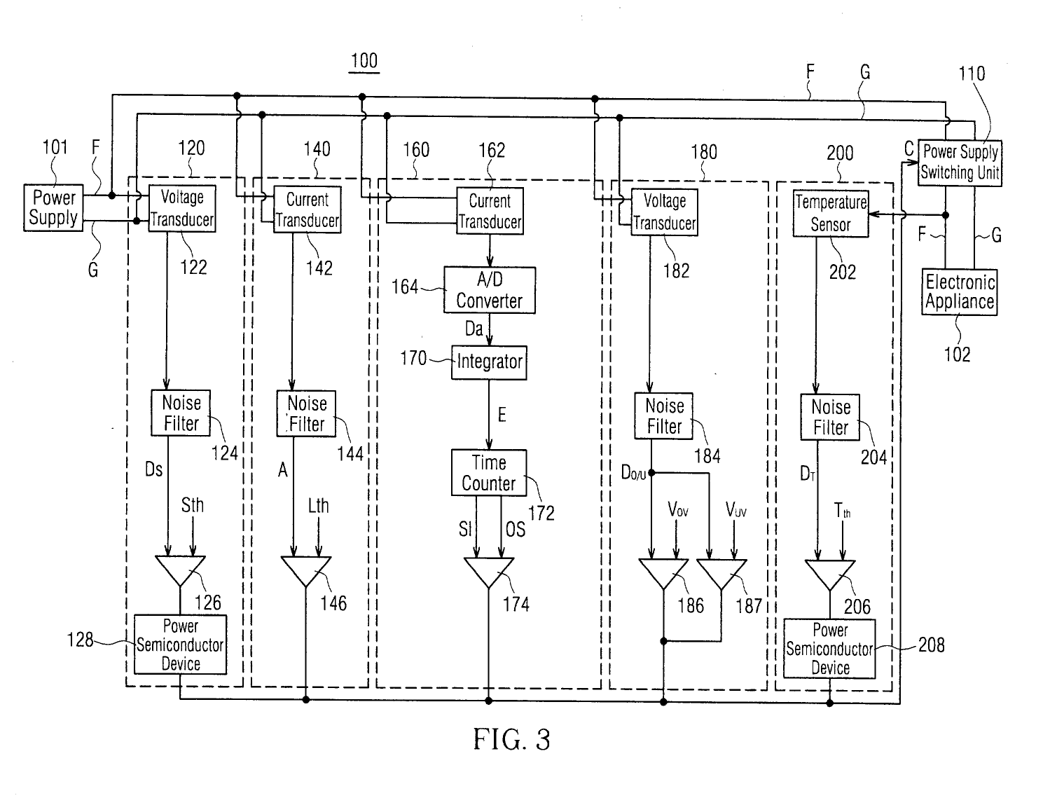

FIG. 4 is a detailed block diagram showing the circuit for power protection according to the embodiment of the present invention, wherein still another example of the overload current protective unit is shown.

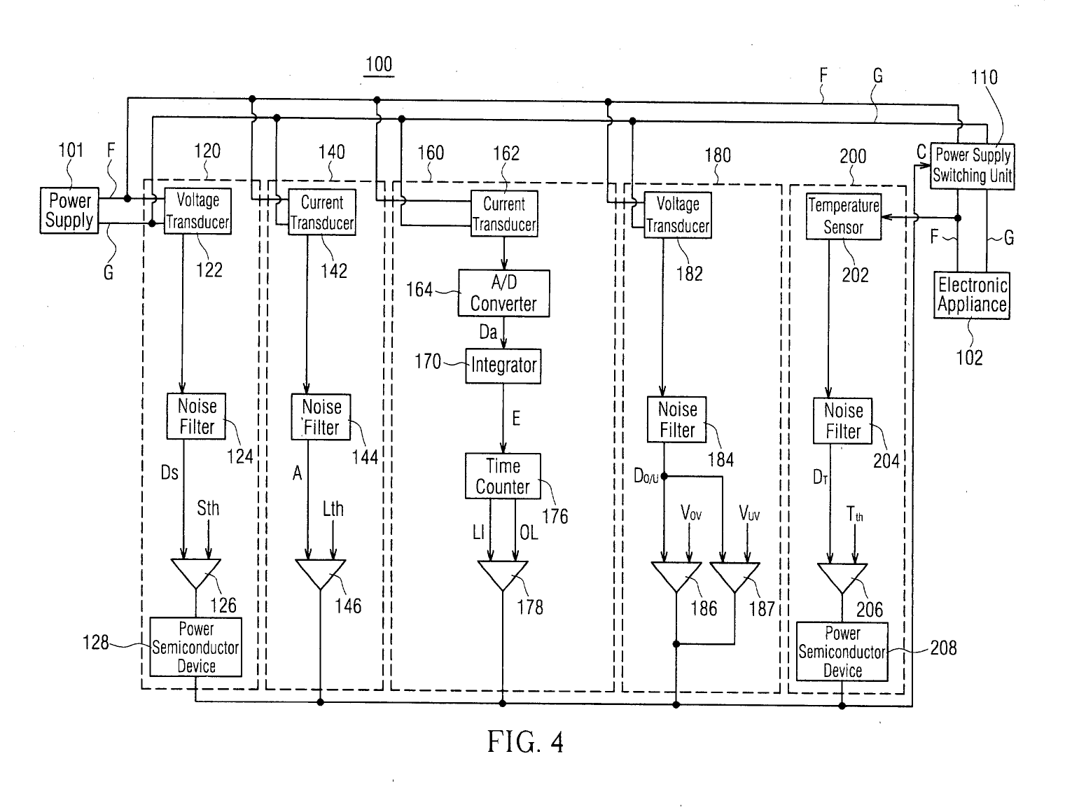

### DETAILED DESCRIPTION OF THE PREFERRED EMBODIMENT

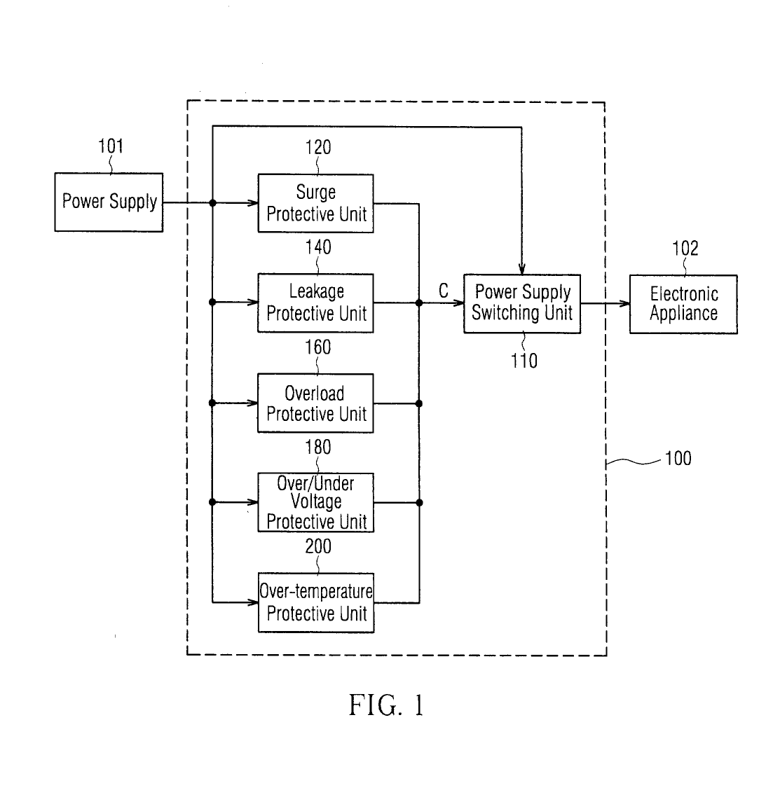

Referring to FIG. 1, a schematic block diagram of a circuit for power protection is shown according to an embodiment of the present invention. The circuit 100 for power protection is electrically connected with a power supply 101 and an electronic appliance 102, so that the circuit 100 can switch the power supply 101 off while the unusual phenomenon of the electronic appliance 102 powered by the power supply 101 occur in order to protect the electronic appliance 102 from damage. The circuit 100 comprises a power supply switching unit 110, a surge protective unit 120, a leakage protective unit 140, an overload protective unit 160, an over/under voltage protective unit 180, and an over-temperature protective unit 200.

The power supply switching unit 110 is electrically connected to the power supply 101 through at least one of the surge protective unit 120, the leakage protective unit 140, the overload protective unit 160, the over/under voltage protective unit 180, and the over-temperature protective unit 200, so that the power supply switching unit 110 switches the power supply 101 off while a switching-off signal C from at least one of the five above-mentioned protective units is outputted to the power supply switching unit 110.

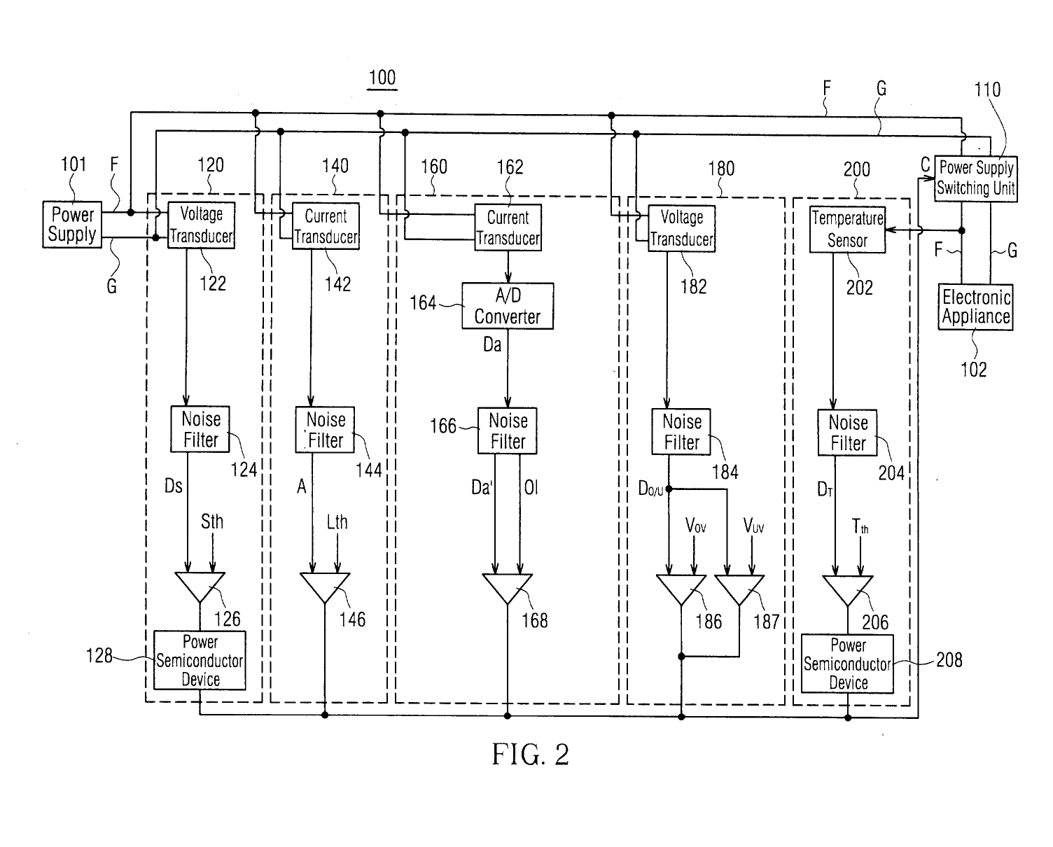

Further, referring to FIG. 2, the block diagram of the circuit 100 shown in FIG. 1 is described in detail. The power supply 101 includes a active line F and a ground line G. The surge protective unit 120 comprises a voltage transducer 122, a noise filter 124, a surge voltage comparator 126, and a power semiconductor device 128. The voltage transducer 122 is electrically connected to the power supply 101 so as to receive the voltage from the power supply 101 and transduce the same into a voltage signal, subsequently the voltage signal is filtered by the noise filter 124, so that a voltage signal Ds is produced. The surge voltage comparator 126 is provided to compare the voltage signal Ds with a surge voltage threshold Sth so as to allow the power semiconductor device 128 to output switching-off signal C while the voltage signal Ds is larger than the surge voltage threshold Sth. The power semiconductor device 128 is coupled with the comparator 126 and the power supply switching unit 110, so that it is possible to clamp the greater current induced by a surge voltage. Preferably, the surge voltage comparator 126 is a digital comparator, and the power semiconductor device 128 is a MOSFET device.

The leakage protective unit 140 comprises a current transducer 142, a noise filter 144, and a leakage current comparator 146. The current transducer 142 is electrically connected to the power supply 101 so as to receive the currents of the active line F and the ground line G and transduce the difference between the currents of the active line F and the ground line G into a current signal, subsequently the current signal is filtered by the noise filter 144, so that a leakage current signal A is produced. The leakage current comparator 146 electrically connected to the power supply switching unit 110 is provided to compare the leakage current signal A with a leakage current threshold Lth so as to output the switching-off signal C while the leakage current signal A is larger than the leakage current threshold Lth. Generally, since human beings may get an electric shock due to the current between 8 mA and 22 mA, thus it is possible to have the leakage current threshold Lth between the above-mentioned range. Preferably, the leakage current comparator 146 is an analogue comparator.

One example of the overload protective unit 160 comprises a current transducer 162, an analogue/digital converter (A/D converter) 164, a noise filter 166, and an instant comparator 168. As for a general electric wire, for example, the electric wire of 10A, the overload protective unit 160 will instantly switch the power supply off while a greater current, for example, the current of 20A is detected. In specific, the current transducer 162 is electrically connected to the power supply 101 so as to receive at least one of the currents of the power supply 101 and transduce the at least one of the currents into a current signal, subsequently the current signal is converted into a digital signal Da by the A/D converter 164. The noise filter 166 filters the digital signal Da, and output a signal Da′ to the instant comparator 168 so as to allow the instant comparator 168 to compare the signal Da′ with an instant threshold OI. Thus, the instant comparator 168 outputs the switching-off signal C while the signal Da′ is larger than the instant threshold OI. Preferably, the instant threshold OI in this example is 20A.

Still, in the case of the same 10A electric wire, it will not cause the damage if the overload current of 10A to 20A occurs in a period. Therefore, it may use another protective countermeasure in accordance with the accumulated energy of the overload current occurring in the period. For example, the allowable period of the occurrence of the overload current of 12A is greater than that of the occurrence of the overload current of 18A. Thus, it may switch the power supply off according to the accumulated energy of the overload current occurring in the period, so that the preferred protection effect is obtained.

The another example of the overload protective unit 160 thus comprises a current transducer 162, the A/D converter 164, an integrator 170, an unusual time counter 172, and an unusual comparator 174. After the integrator 170 receives a digital signal Da, a calculation is performed based on the digital signal Da so as to output an energy signal E. Preferably, the calculation includes at least one accumulated calculation. The unusual time counter 172 receives the energy signal E so as to calculate the energy SI accumulated during a short time interval and output the same. The unusual comparator 174 compares the energy SI with an unusual threshold OS, so that the switching-off signal C is outputted while the energy SI is larger than the unusual threshold OS. Preferably, the short time interval is substantially lay in between 3 seconds and 5 seconds.

Further, the still another example of the overload protective unit 160 comprises the current transducer 162, the A/D converter 164, the integrator 170, an overtime counter 176, and an overtime comparator 178. The overtime counter 176 receives the energy signal E so as to calculate the energy SI accumulated during a long time interval and output the same. The overtime comparator 178 compares the energy SI with an overload current threshold OL, so that the switching-off signal C is outputted while the energy SI is larger than the overload current threshold OI. Preferably, the long time interval is substantially lay in between 3 minutes and 5 minutes.

It should be understood that the above-mentioned three examples of the overload protective unit 160 may be provided at the same time, and in the case of providing with the three examples at the same time, the current transducer 162, the A/D converter 164, and the integrator 170 are used in common.

The over/under voltage protective unit 180 comprises a voltage transducer 182, a noise filter 184, and over/under voltage comparators 186, 187. The voltage transducer 182 is electrically connected to the power supply 101 so as to receive the voltage from the power supply 101 and transduce the same into a voltage signal, subsequently the voltage signal is filtered by the noise filter 184, so that a voltage signal Do/u is produced. The over/under voltage comparators 186, 187 compare the voltage signal Do/u with over/under voltage thresholds Vov, Vuv, respectively, so that the switching-off signal C is outputted while the voltage signal Do/u is larger than the over voltage threshold Vov or less than the under voltage threshold Vuv. Preferably, the over/under voltage comparators 186, 187 are digital comparators, and the filtering cycle of the noise filter 184 is substantially larger than 50 ms.

The over-temperature protective unit 200 comprises a temperature sensor 202, a noise filter 204, a temperature comparator 206, and a power semiconductor device 208. The temperature sensor 202 is connected to the active line F of the power supply 101 so as to measure the temperature of the active line F and transduce the same into a temperature signal, subsequently the temperature signal is filtered by the noise filter 204, so that a temperature signal DT is produced. The temperature comparator 206 compares the voltage signal DT with a temperature threshold Tth, so that the power semiconductor device 208 may output the switching-off signal C while the voltage signal DT is larger than the temperature threshold Tth. On the other hand, the power semiconductor device 208 may output a switching-on signal to the power supply switching unit 110 while the temperature of the active line F returns to the one substantially less than the temperature threshold Tth, so that the power supply switching unit 110 returns to electrical conduction. Preferably, the power semiconductor device 208 is a MOSFET device.

It should be understood that, in comparison with the conventional circuit for power protection, it required a combination of at least five circuits for power protection with respective distinct functions such that the effects of the surge voltage protection, the leakage current protection, the overload current protection, the over/under voltage protection, and temperature protection are achievable. However, according to the present invention, the circuits for power protection with respective distinct functions are integrated into one circuit, thereby the volume of the circuit is reduced and the cost thereof is also reduced. In addition, the overload protective unit 160 of the present invention may determine the unusual overload current by the energy SI accumulated during the time intervals, so that the effect of more precise and safer power supply protection is obtained.

The present invention is not limited to the above-described embodiments, but can be modified and applied in various ways. Various embodiments and changes may be made thereunto without departing from the broad spirit and scope of the invention. The above-described embodiments are intended to illustrate the present invention, not to limit the scope of the present invention. The scope of the present invention is shown by the attached claims rather than the embodiments. Various modifications made within the meaning of an equivalent of the claims of the invention and within the claims are to be regarded to be in the scope of the present invention.

What is claimed is:

1. A circuit for power protection, which is electrically connected to a power, supply including a active line and a ground line, comprising:
a power supply switching unit electrically connected to the power supply; and
an over-temperature protective unit connected to the power supply switching unit and coupled to the active line of the power supply;
wherein the over-temperature protective unit may output a switching-off signal to the power supply switching unit while a temperature value of the active line detected by the over-temperature protective unit is larger than a temperature threshold so as to switch the power supply off, and the over-temperature protective unit may output a switching-on signal to the power supply switching unit while another temperature value of the active line detected by the over-temperature protective unit returns to the one substantially less than the temperature threshold so as to switch the power supply off.

2. The circuit as recited in claim 1, wherein the over-temperature protective unit comprising:
a temperature sensor connected to the active line of the power supply;
a comparator connected to the temperature sensor; and
a power semiconductor device connected to the comparator and coupled to the power supply switching unit;
wherein the temperature sensor may transduce the temperature value of the active line into a signal so as to allow the comparator to receive the signal and to compare the same with the temperature threshold, thus the power semiconductor device may output the switching-off signal or the switching-on signal to the power supply switching unit.

3. The circuit as recited in claim 2, wherein the over-temperature protective unit further comprising:
a noise filter connected to the temperature sensor and the comparator;
wherein the signal is filtered by the noise filter so as to output the filtered signal to the comparator.

4. The circuit as recited in claim 1, further comprising a surge protective unit electrically connected to the power supply, the over-temperature protective unit, and the power supply switching unit, wherein the surge protective unit comprising:
a voltage transducer electrically connected to the power supply and the power supply switching unit;
a comparator connected to the voltage transducer; and
a power semiconductor device connected to the comparator and coupled to the power supply switching unit;
wherein the voltage transducer may receive a voltage value of the power supply and transduce the same into a voltage signal so as to allow the comparator to receive the voltage signal and to compare the voltage signal with a surge voltage threshold, thus the power semiconductor device may output the switching-off signal to the power supply switching unit,
wherein the power semiconductor device is used to clamp the greater current induced by a surge voltage while the surge voltage is occurred so as to protect the surge protective unit from damage.

5. The circuit as recited in claim 4, wherein the surge protective unit further comprising:
a noise filter connected to the voltage transducer and the comparator;
wherein the voltage signal is filtered by the noise filter so as to output the filtered signal to the comparator.

6. The circuit as recited in claim 1, further comprising a leakage protective unit electrically connected to the power supply, the over-temperature protective unit, and the power supply switching unit, wherein the leakage protective unit comprising:
a current transducer electrically connected to the power supply and the power supply switching unit; and
a comparator connected to the current transducer and coupled to the power supply switching unit;
wherein the current transducer may receive both currents of the active line and the ground line and transduce a difference therebetween into a current signal so as to allow the comparator to receive the current signal and to compare the current signal with a leakage current threshold, thus the comparator may output the switching-off signal to the power supply switching unit.

7. The circuit as recited in claim 6, wherein the leakage protective unit further comprising:
a noise filter connected to the current transducer and the comparator;
wherein the current signal is filtered by the noise filter so as to output the filtered signal to the comparator.

8. The circuit as recited in claim 1, further comprising an overload protective unit electrically connected to the power supply, the over-temperature protective unit, and the power supply switching unit, wherein the overload protective unit comprising:
a current transducer electrically connected to the power supply and the power supply switching unit;
an analogue/digital converter connected to the current transducer; and
a comparator connected to the analogue/digital converter and coupled to the power supply switching unit;
wherein the current transducer may receive either a current value of the active line or a current value of the ground line and transduce the same into a current signal so as to allow the analogue/digital converter to convert the current signal into a digital signal, thus the comparator may compare the digital signal with an instant threshold and output the switching-off signal to the power supply switching unit.

9. The circuit as recited in claim 8, wherein the overload protective unit further comprising:
a noise filter connected to the analogue/digital converter and the comparator;
wherein the digital signal is filtered by the noise filter so as to output the filtered signal to the comparator.

10. The circuit as recited in claim 1, further comprising an overload protective unit electrically connected to the power supply, the over-temperature protective unit, and the power supply switching unit, wherein the overload protective unit comprising:
a current transducer electrically connected to the power supply and the power supply switching unit;
an analogue/digital converter connected to the current transducer;
an integrator connected to the analogue/digital converter;
a time counter connected to the integrator; and
a comparator connected to the time counter and coupled to the power supply switching unit;
wherein the current transducer may receive either a current value of the active line or a current value of the ground line and transduce the same into a current signal so as to allow the analogue/digital converter to convert the current signal into a digital signal, subsequently the integrator may perform a calculation based on the digital signal so as to output an energy signal to the time counter, thus the time counter output an accumulated energy signal during a short time interval so as to allow the comparator to compare the accumulated energy signal with an unusual threshold and output the switching-off signal to the power supply switching unit.

11. The circuit as recited in claim 1, further comprising an overload protective unit electrically connected to the power supply, the over-temperature protective unit, and the power supply switching unit, wherein the overload protective unit comprising:
a current transducer electrically connected to the power supply and the power supply switching unit;
an analogue/digital converter connected to the current transducer;
an integrator connected to the analogue/digital converter;
a time counter connected to the integrator; and
a comparator connected to the time counter and coupled to the power supply switching unit;
wherein the current transducer may receive either a current value of the active line or a current value of the ground line and transduce the same into a current signal so as to allow the analogue/digital converter to convert the current signal into a digital signal, subsequently the integrator may perform a calculation based on the digital signal so as to output an energy signal to the time counter, thus the time counter output an accumulated energy signal during a long time interval so as to allow the comparator to compare the accumulated energy signal with an overload current threshold and output the switching-off signal to the power supply switching unit.
